(19) United States
(12) Patent Application Publication
(10) Pub. No.: US 2010/0154816 A1
(43) Pub. Date: Jun. 24, 2010

(54) Method for Testing and Practicing Application of Highlights to Hair

(76) Inventors: Lorri Goddard-Clark, Los Angeles, CA (US); Shari Glazer, Pacific Palisades, CA (US)

Correspondence Address: Woods Oviatt Gilman LLP, 700 Crossroads Bldg, 2 State St., Rochester, NY, 14614, US

(21) Appl. No.: 12/339,283

(22) Filed: Dec. 19, 2008

(51) Int. Cl. A61Q 5/00; G09B 19/00

(52) U.S. Cl. 132/208; 132/200; 434/219

(57) ABSTRACT

A method for practicing the application and placement of highlights to hair includes providing a non-permanent highlighting mixture preferably comprising white henna powder mixed with a liquifier such as hair conditioner, for example. The person uses the non-permanent highlighting mixture to practice their techniques and placement of highlights to their hair. The non-permanent highlighting mixture may be washed out or combed through the hair for a conditioning treatment. The practice highlighting mixture may be repeatedly applied to the hair with no permanent or adverse effects on the hair. Once the person is satisfied with their application technique and placement they may proceed to apply a permanent highlighting mixture to the hair.

### BACKGROUND OF THE INVENTION

The present invention generally relates to hair coloring methods. More particularly, the present invention relates to a method for testing and practicing application of highlights to hair.

Hair highlighting has become very popular in recent years. The term “highlighting” generally refers to the application of a lighter color to sections of hair rather than an entire head of hair so as to provide a contrast between these sections and the rest of the hair on the person's head. In highlighting hair, a bleach and peroxide mixture can be used to “decolorize” the hair, or hair color dyes can be used to lighten and deposit color to the hair. This process is also used in applying “low-lights” to the hair. In this process, hair dyes are used to create strands of hair that are darker than the natural color.

There are different methods for applying highlights to hair. For example, in the foil or paper method, selected sections of hair are separated from the rest of the hair and a foil or paper is placed beneath the section typically but not always close to the scalp. The highlight colorant or bleach is then applied to the hair section with a brush and then covered for a period of time to allow the colorant or bleach to penetrate the hair. Application of highlights is repeated on as many selected hair sections as desired to give the targeted effect. In another hair highlighting method referred to as “Balayage”, sections of hair are supported by a paddle and the highlights are applied to the hair section which are then allowed to hang free while processing. In yet another highlighting method known as the “cap” method, a specially designed cap having small openings is placed on the head and hair sections are drawn through the holes in the cap using a tool similar to a crochet needle. The highlighting mixture is applied to the hair strands while the hair beneath the cap is protected.

It is well known that application of highlights to hair requires skill and experience to achieve the desired effect. For example, should the person select hair sections which are too thick, too thin or poorly spaced on the head, the results could be very unflattering and this is only known after the highlighting process is complete and permanent. Unfortunately, many people attempting to use home hair highlighting kits do not have the skill (technique) or experience and end up with unsatisfactory and disappointing results. Since the highlighting is permanent (or at least semi-permanent, e.g., removed after a certain number of washings), the unsatisfied person has the choice of waiting for the hair to grow out or highlights fade, cutting it (and the highlights) away, or attempting to re-color the hair. None of these choices are particularly attractive and there therefore remains a need for a method allowing a person to practice applying non-permanent highlights to hair so as to allow the person to see highlighting results before they become permanent while also allowing the person to improve their application technique prior to application of permanent or semi-permanent highlights to hair.

### SUMMARY OF THE INVENTION

The present invention addresses the above need by providing a method for practicing applying non-permanent highlights to hair. In a preferred embodiment, a practice highlighting mixture is provided in the form of a white henna powder which may be mixed with any suitable liquefying agent and is preferably mixed with hair conditioner. White henna itself is made from a mixture of magnesium carbonate, kaolin, and clay and is commercially available through Colora, Box 887, NY, N.Y. 10150, for example. A hair conditioner, which acts as a liquifyer, is then mixed with the white henna to achieve the desired consistency. The practice highlighting mixture mimics the look and feel of permanent highlighting powder but doesn't have any permanent color or highlighting properties. The user is thus able to see their results and adjust their application technique until they achieve the desired look. After each practice session, the practice highlighting mixture may thereafter be easily combed through the hair. Thus, with highlighting mixture having hair conditioner incorporated therein, the hair thus also receives the benefit of a deep conditioning treatment. Since the highlighting test mixture is non-permanent, the person may practice the highlighting application technique many times. Once the person feels confident they have perfected their technique and are satisfied with the highlighting placement on the hair, they may switch over to using a permanent hair highlighting mixture.

### BRIEF DESCRIPTION OF THE DRAWING

FIG. 1 is a perspective view of a person having a section of hair lifted from the head for application of a highlighting mixture;

FIG. 2 is the view of FIG. 1 showing placement of a highlighting foil beneath the section of hair;

FIG. 3 is the view of FIG. 2 showing application of the hair highlighting mixture to the hair section;

FIG. 4 is a perspective view showing placement of the highlights on the hair; and

FIG. 5 is a perspective view of a kit according to an embodiment of the invention.

### DETAILED DESCRIPTION

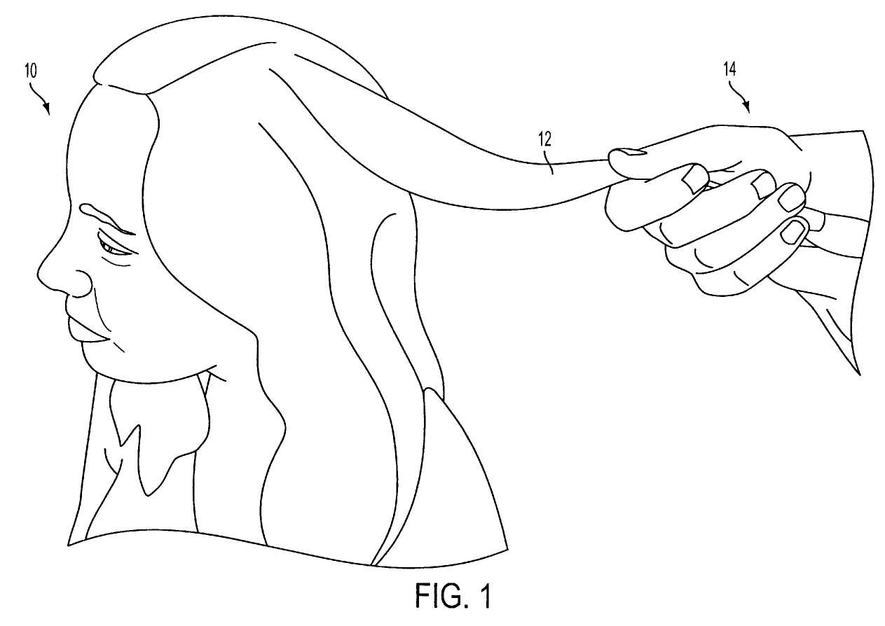

Referring now to the drawing, there is seen in FIG. 1 a person 10 having a section of hair 12 lifted to begin the highlighting application method. Although a second person 14 may perform the highlighting application process, it is understood the present inventive method may be performed by the person 10 alone.

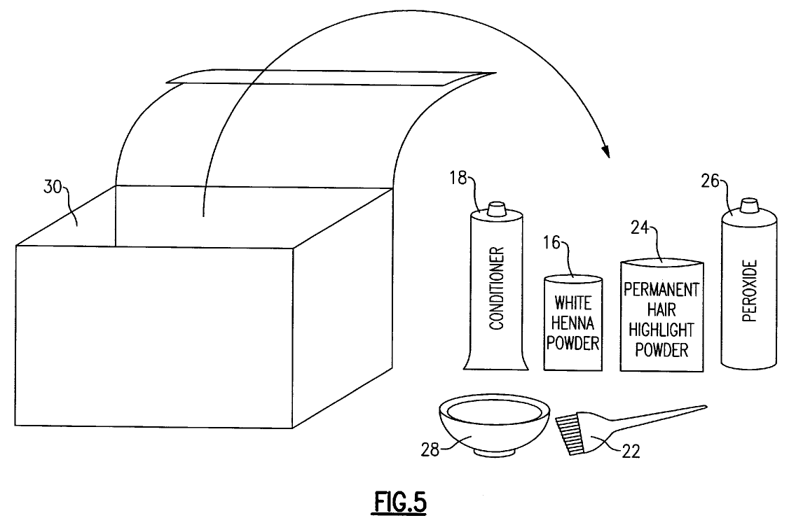

As discussed above, in a preferred embodiment, a practice highlighting mixture is provided in the form of a white henna powder 16 mixed with a suitable liquefying agent, preferably hair conditioner 18 (FIG. 5). White henna powder 16 may be made from a mixture of magnesium carbonate, kaolin, and clay and is commercially available through Colora, Box 887, NY, N.Y. 10150, for example. Hair conditioner 18 and/or other suitable liquifiers may then be mixed with the white henna powder 16 to achieve the desired consistency. Any type of conditioner and/or other suitable hair treatment additives may be used, for example, silicone, quaternary ammonium compounds, moisturizers, reconstructors, acidifiers, detanglers, thermal protectors, glossers, oils (EFAs—essential fatty acids), surfactants, lubricants, (e.g., fatty alcohols, panthenol, dimethicone, etc.), sequestrants, antistatic agents and preservatives.

It is preferred that the practice highlighting mixture generally mimics the look and feel of a permanent highlighting mixture but doesn't have any permanent color or highlighting properties. The user is thus able to see their results and adjust their application technique until they achieve the desired look.

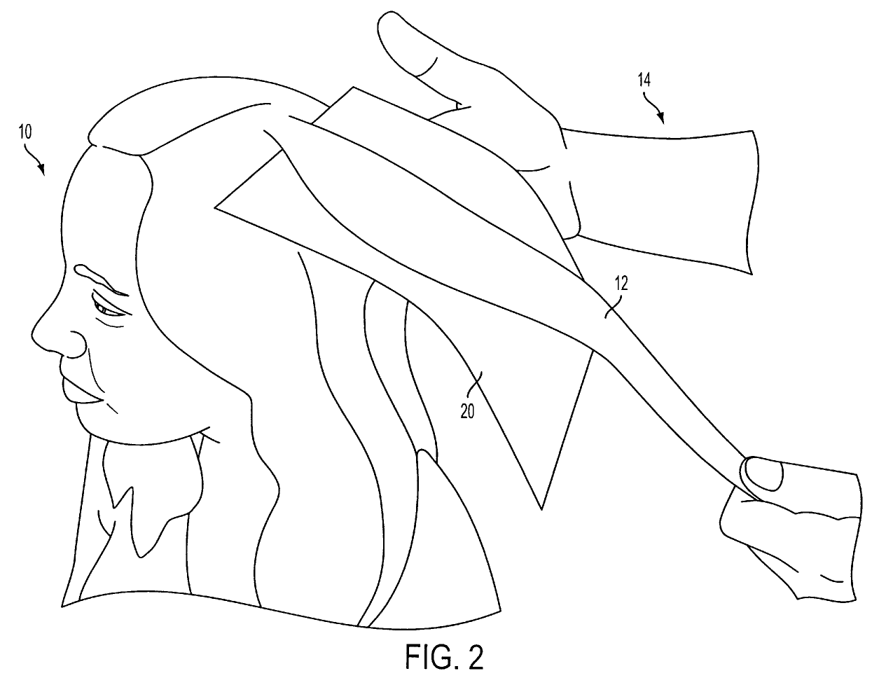

FIG. 2 illustrates positioning a piece of foil or paper 20 beneath the section of hair 12 to provide support during the highlight application process although the use of a paper or foil or any other hair handling component is of course optional.

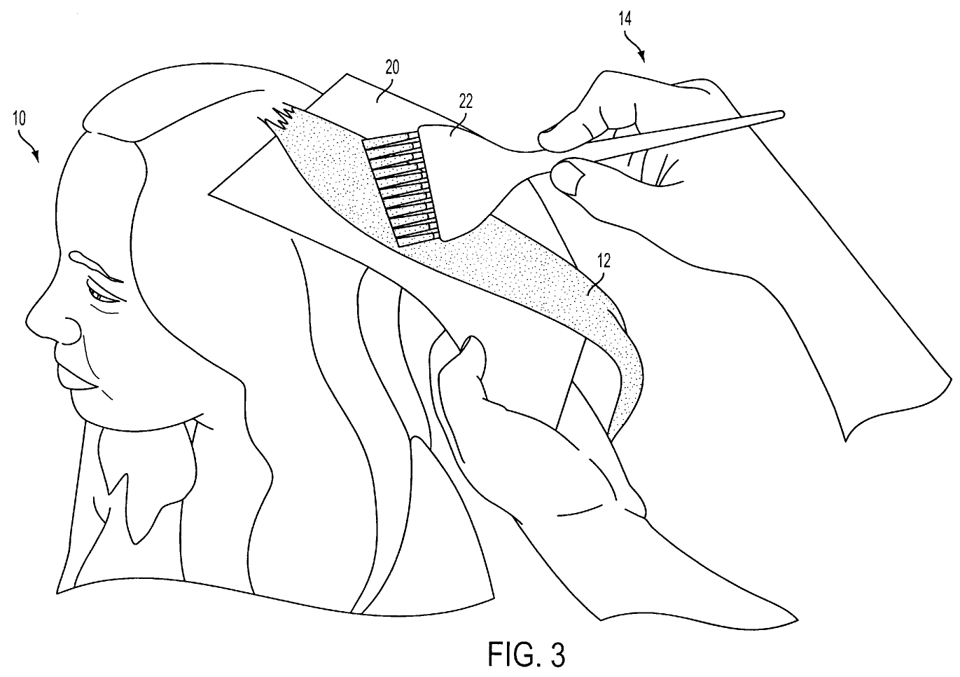

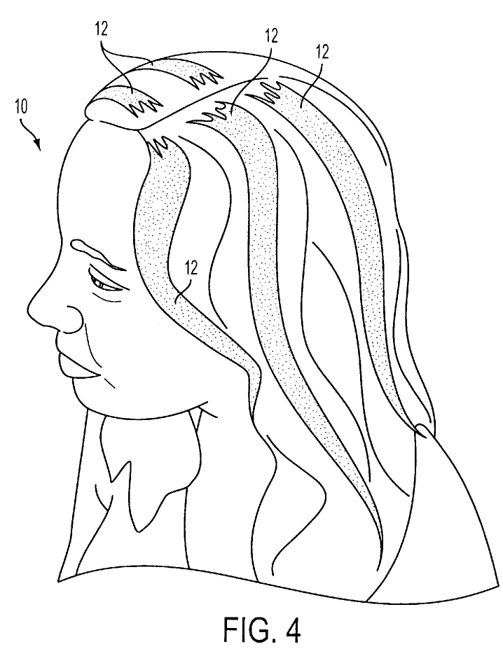

FIG. 3 illustrates application of the practice highlighting mixture (indicated by stippling) to the hair section using a brush 22 or other suitable applicator. FIG. 4 illustrates the varied placement of the practice highlighting mixture to various strands of hair 12 about the person's head. Since the highlighting mixture is very light in color, the person may readily see how the highlights are placed and decide whether they like the placement or think the placement should be changed. If they like the placement, the person may either wash out or comb the highlighting mixture through their hair. In the embodiment where the mixture contains hair conditioner, the conditioner will condition the hair and the person thus receives the two-fold benefit of having a highlighting mixture for practicing highlighting application and placement technique while at the same time receiving a conditioning hair treatment. The person may thereafter apply permanent highlights to the hair using the technique and placement they used with the non-permanent highlighting mixture. On the other hand, if they do not like the placement, the person may repeat the removal and application process with the non-permanent highlighting mixture as many times as they wish or until they are pleased with their (or other person's) technique and placement, at which time they may apply permanent highlights as explained above.

As seen in FIG. 5, the non-permanent hair highlighting mixture comprising white henna powder 16 and conditioner 18 may be provided in a kit 30 which may further include one or more additional hair treatments items such as a permanent hair highlighting powder 24 and peroxide 26 (to be used once the person has perfected their application technique as discussed above), applicator brush 22, mixing bowl 28. Although not shown, foils or cap, shampoo cape and mirror are examples of additional items that may be included within kit 30 as desired.

What is claimed is:

1. A method for practicing application technique and placement of highlights to hair, said method comprising the steps of:
a) providing a non-permanent highlighting mixture;
b) applying said non-permanent highlighting mixture to selected sections of hair on a person's head;
c) removing or distributing said non-permanent highlighting mixture through the person's hair; and
d) repeating steps a) through c) until the desired application technique and placement of the non-permanent highlighting mixture is achieved.

2. The method of claim 1 and, following achievement of the desired application technique and placement of the non-permanent highlighting mixture, further comprising the additional steps of providing and applying a permanent highlighting mixture to selected strands of hair.

3. The method of claim 1 wherein said non-permanent highlighting mixture includes magnesium carbonate, kaolin, and clay.

4. The method of claim 1 wherein said non-permanent highlighting mixture includes a hair conditioner.

5. The method of claim 3 wherein said non-permanent highlighting mixture includes a hair conditioner.

6. The method of claim 4 and further comprising the step of distributing said highlighting mixture throughout the hair between steps c) and d).

7. The method of claim 5 and further comprising the step of distributing said highlighting mixture throughout the hair between steps c) and d).
